(19) United States
(12) Patent Application Publication
(10) Pub. No.: US 2018/0227314 A1
(43) Pub. Date: Aug. 9, 2018

(54) SYSTEM AND METHOD FOR PERFORMING ANTIVIRUS SCAN OF A WEB PAGE

(71) Applicant: AO Kaspersky Lab, Moscow (RU)

(72) Inventors: Anton B. Galchenko, Moscow (RU); Mikhail V. Ustinov, Moscow (RU)

(21) Appl. No.: 15/620,121

(22) Filed: Jun. 12, 2017

(30) Foreign Application Priority Data
Feb. 8, 2017 (RU) 2017104132

(51) Int. Cl. H04L 29/06; G06F 9/50

(52) U.S. Cl. CPC H04L 63/145; G06F 2209/501; G06F 9/5027

(57) ABSTRACT

Disclosed are systems and methods for performing an antivirus scan of a web page by an antivirus system. The system includes an antivirus server and a client module executed by a web browser application. The disclosed technique includes detecting text in markup language of a web page being opened, generating text set in the markup language of the web page, determining a capacity of a communications channel between the client module and the antivirus server, and determining a productivity reserve of the antivirus server. The antivirus server may select a speed of dispatching information from the client module to the antivirus server and performs the antivirus scan of the generated text set in markup language of the web page being opened using a portion of the determined productivity reserve that is allocated based on the selected information dispatching speed.

### CROSS-REFERENCE TO RELATED APPLICATIONS

This application claims benefit of priority under 35 U.S.C. 119(a)-(d) to a Russian Application No. 2017104132 filed on Feb. 8, 2017, which is incorporated by reference herein.

### FIELD OF TECHNOLOGY

The present disclosure relates to systems and methods for performing an antivirus scan on a web page, and, in particular, to systems and methods of allocating the productivity reserve of an antivirus server.

### BACKGROUND

The volume of information processed by servers is constantly growing each day. An unregulated flow of requests in the course of data processing by a server often results in a nonworking state of the server. Failure results from overloading of the request queue and the physical limitation of the resources of computer technology. In order to monitor the load on server resources, methods are used to analyze the request flow and the request queue. The monitoring process is made harder due to an uncontrollable increase in the number of requests.

A shutdown of computer systems which are handling the processing of requests causes harm to the productivity of complex computer systems whose working is based on the sending or receiving of requests. In this regard, some of the mentioned systems interrupt the execution of tasks and go into a waiting mode until the request execution is completed. One such system is a system that scans files for the presence of malicious code with the use of remote computer systems or servers. In such a case, there is a drop in one of the fundamental indicators of the effectiveness of such systems—the level of detection.

One common architecture for executing requests uses at least three components: an element which generates and makes the request, a communications channel, and an element which processes the received request and issues the response. The element which generates and makes the request can be an application installed on a computer system. The element which processes the received request can be a computer system of the server type, which contains a repository of data or functionalities by virtue of which the request will be processed and a response to the request will be produced. The communications channel is a known type of connection enabling a transfer of data from one element to another.

While known techniques may perform some kind of monitoring of the process of request execution, the known techniques do not identify the optimal allocation of productivity reserve of the antivirus server when performing the antivirus scan of web pages. The present disclosure allows an effective solution to this problem.

### SUMMARY

Disclosed are systems and methods of controlling the productivity of an antivirus server. The technical result of the present disclosure increases the effectiveness of use of the productivity reserve of an antivirus server when performing an antivirus scan of a web page. Said technical result is accomplished by allocating a portion of the productivity reserve of the antivirus server for performing the antivirus scan of a web page in accordance with a selected speed of dispatching information from the module of the antivirus system for scanning web pages to the antivirus server. The speed of dispatching information is determined on the basis of a generated text set in markup language of the web page being opened for the antivirus scan, the communications channel capacity between the module of the antivirus system for scanning web pages and the antivirus server, and the productivity reserve of the antivirus server, making use of speed selection rules.

In one exemplary aspect, a system for performing an antivirus scan of a web page by an antivirus system is provided. The system includes an antivirus server; and a client module of the antivirus system for scanning of web pages module. The client module is configured to: detect text in markup language of a web page being opened; generate a text set in the markup language of the web page being opened for the antivirus scan; determine a capacity of a communications channel between the client module and the antivirus server; and determine a productivity reserve of the antivirus server. The antivirus server is configured to: select a speed of dispatching information from the client module to the antivirus server based on the generated text set in markup language of the web page being opened for the antivirus scan, the determined capacity of the communications channel, and the determined productivity reserve of the antivirus server; and allocate a portion of the determined productivity reserve of the antivirus server to perform the antivirus scan of the generated text set in markup language of the web page being opened, based on the selected information dispatching speed; and perform the antivirus scan of the generated text set in markup language of the web page being opened using the allocated portion of the productivity reserve of the antivirus server.

In one further exemplary aspect, the antivirus server is further configured to select the speed of dispatching information from the module of the antivirus system for scanning of web pages to the antivirus server further based on at least one speed selection rule from a rules database.

In one further exemplary aspect, the client module configured to detect text in markup language of a web page being opened is further configured to: detect a successful execution of a series of interactions with a graphical user interface of the web browser that signify an opening of the web page in the web browser.

In one further exemplary aspect, the client module configured to detect text in markup language of a web page being opened is further configured to: detect a transition by a hyperlink located on the web page being opened.

In one further exemplary aspect, the client module configured to detect text in markup language of a web page being opened is further configured to detect one or more events generated by the web browser which indicate alteration of a document object of the web page being opened.

In one further exemplary aspect, the client module configured to generate the text set in the markup language of the web page being opened for the antivirus scan is further configured to add strings containing an insertion of program text in a programming language.

In one further exemplary aspect, the client module configured to generate the text set in the markup language of the web page being opened for the antivirus scan is further configured to add characters and strings of text in markup language of the web page being opened that contain a tag.

In one further exemplary aspect, the client module configured to determine the capacity of the communications channel between the client module and the antivirus server is further configured to dispatch a plurality of requests containing a verified text set in markup language of a predetermined size, detect receipt of the requests, and calculate time spent on transmission of the verified text set in markup language of predetermined size.

In one further exemplary aspect, the client module configured to determine the productivity reserve of the antivirus server is further configured to perform a forced antivirus scan of a verified text set in markup language of predetermined size, and calculate time spent on scanning the verified text set.

In another exemplary aspect, a method is provided for performing an antivirus scan of a web page by an antivirus system. The method includes receiving, from a client module of a web browser application, a text set generated based on markup language of a web page being opened for an antivirus scan; receiving an indication of a capacity of a communications channel between the client module and an antivirus server; determining a productivity reserve of the antivirus server; selecting a speed of dispatching information from the client module to the antivirus server based on the received text set in markup language of the web page being opened for the antivirus scan, the received capacity of the communications channel, and the determined productivity reserve of the antivirus server; allocating a portion of the determined productivity reserve of the antivirus server to perform the antivirus scan of the generated text set in markup language of the web page being opened, based on the selected information dispatching speed; and performing, by the antivirus server, the antivirus scan of the generated text set in markup language of the web page being opened using the allocated portion of the productivity reserve of the antivirus server.

According to another exemplary aspect, a method is provided for performing an antivirus scan of a web page by an antivirus system. The method includes detecting, by a client module of the antivirus system, text in markup language of a web page being opened; generating a text set in the markup language of the web page being opened for the antivirus scan; determining a capacity of a communications channel between the client module and an antivirus server; determining a productivity reserve of the antivirus server; and transmitting, to the antivirus server, the web page being opened, to perform the antivirus scan, according to a dispatching information speed selected based on the determined capacity of the communications channel and the determined productivity reserve of the antivirus server.

According to another exemplary aspect, a computer-readable medium is provided comprising instructions that comprises computer executable instructions for performing any of the methods disclosed herein.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of an antivirus system for scanning web pages and an antivirus server according to an exemplary aspect.

FIG. 2 illustrates a block diagram of an example system for allocating a portion of productivity reserve of the antivirus server in performing the antivirus scan of a web page according to an exemplary aspect.

FIG. 3 illustrates a flowchart of a method for allocating a portion of the productivity reserve of the antivirus server in performing the antivirus scan of a web page according to an exemplary aspect.

FIG. 4 illustrates a block diagram of an example of a general-purpose computer system on which the disclosed system and method can be implemented according to an exemplary aspect.

### DETAILED DESCRIPTION

Example aspects are described herein in the context of a system, method and computer program product for performing an antivirus scan of a web page. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

A web browser is an application (hardware or software) designed to receive and process user requests for access to the Internet (to visit a web page), transmit the request to the Internet, and process a response to this request from the Internet (a server containing the web page). The main function of a web browser is the processing and displaying of the web page received in response to the request. A web browser extension, also known as a web browser add-on or a web browser plug-in, is a software component, launched by the web browser, which alters or extends the functional capabilities of the web browser.

A web page is a document whose text is composed in markup language, for example in hypertext markup language (HTML). The text of a web page in markup language (also referred to herein more simply as “markup text”), for example in accordance with the rules and specification of HTML, may contain characters and strings with the text of programs written in other programming languages (such as JavaScript, ECMA-262), which need to be separated by tags of markup language (such as <script>, </script>). In order to execute the strings and characters of text of programs in a programming language, the web browser can use an additional tool, extension or library (API) containing a compiler or interpreter for that program text or code.

In some cases, web pages can be specially created or modified to perform malicious actions upon being opened and processed by a web browser. To create or modify such a web page to perform malicious actions, a hacker might create and insert into the text of the web page being opened different markup text whose processing by the web browser results in the performance of malicious actions. That is, the text in markup language whose processing by the browser results in performance of malicious actions contains characters or strings in markup language whose processing by the web browser performs a malicious action.

Code injection, or more specifically, web injection, is a technique for exploiting web browsers in which text in a markup language not originally belonging to the web page being opened is inserted in the course of the opening of the web page. The inserted text may contain text in markup language with insertions of program text in a programming language (such as in JavaScript). As an example, web injections are often used by Trojan banking applications to perform malicious actions with user bank accounts. The known Trojans Zeus and SpyEye are among the first to use web injections to compromise banking sites and alter their content.

Another example of text in markup language whose processing by a browser results in performance of malicious actions are characters or strings of markup text using certain tags that have been characterized as suspicious because of their ability to incorporate external files and media, such as <iframe>, <object>, <embed>. The text within the tags may contain links to unknown or suspicious resources. Of special interest are the attributes used in the tags. For example, attributes influencing the external appearance of the information being displayed may signify attempts to mask or disguise malicious actions using techniques for stealthiness in page viewing, for example, very small values of the attributes width/height (0-10 pixels) to minimize the visible size, positioning tricks to align information in non-visible regions (e.g., “position:absolute”) and other stylesheet tricks for controlling how content is rendered on the webpage (e.g., “display:none”).

In order to provide safety when opening web pages, an antivirus scan of the web pages being opened can be performed. An antivirus scan of web pages is a scan of the text of the web pages in markup language for the presence of markup text whose processing by the web browser results in the performance of malicious actions. The antivirus scan of web pages is done with the aid of an antivirus system configured for the antivirus scanning of web pages.

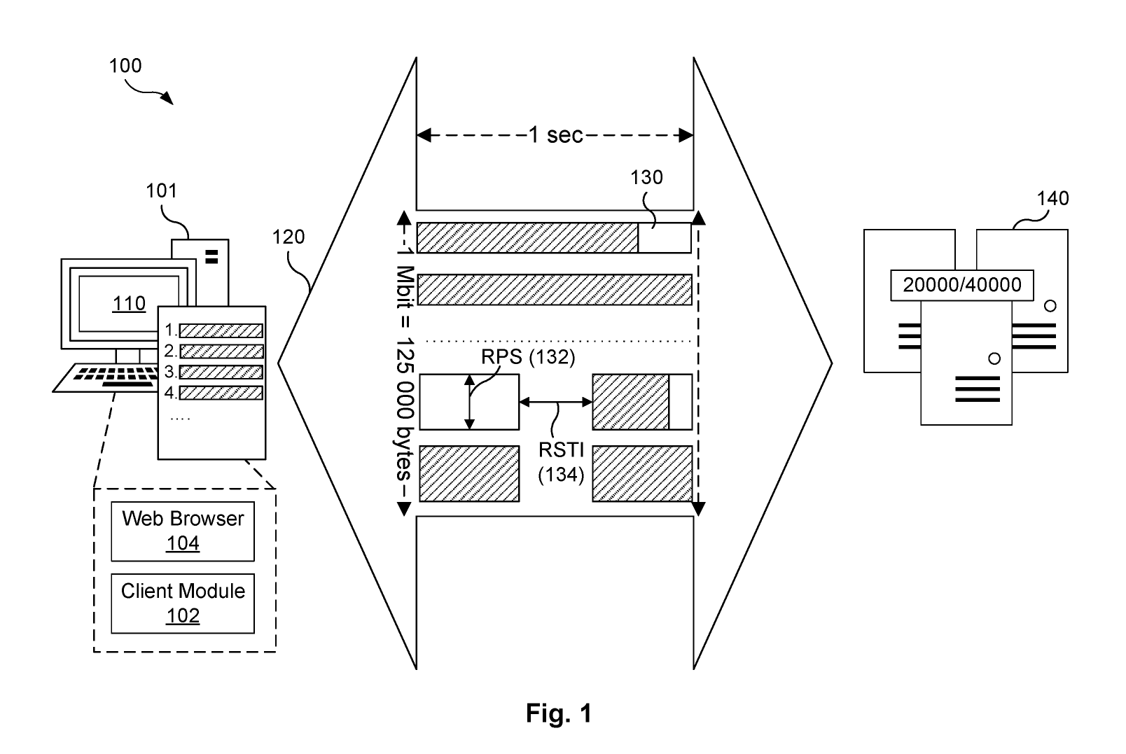

FIG. 1 shows an example of an antivirus system 100 for scanning web pages according to an exemplary aspect. The system 100 includes a client module 102 of the antivirus system 100 for scanning web pages 110 configured to send requests 130 to an antivirus server 140 for the scanning of web pages with the use of an available communications channe1120.

In one exemplary aspect, the client module 102 of the antivirus system for scanning web pages 110 is configured to gather and process text of web pages 110 in markup language that are being opened by a web browser application 104. In one exemplary aspect, the client module 102 of the antivirus system for scanning web pages 110 is an installable module embodied in the form of a browser extension. In this case, the antivirus system scans all web pages being opened in the web browser 104 with the installed module. In another exemplary aspect, the client module 102 of the antivirus system for scanning web pages 110 is implemented as strings of text of the web page being opened in markup language with insertions of application text in a programming language (such as JavaScript), which is added at the behest of the web page owner. In this case, the client module 102 switches to an active state after opening the web page, and the antivirus system performs a scanning of only the opened web page, with the client module 102 added to the text of the web page in markup language.

In one exemplary aspect, the client module 102 of the antivirus system for scanning web pages 110 may not have functionality that performs an antivirus scan of web pages on the computer system 101 with the web browser 104 that was used to open the web pages. Rather, based on the text of the web pages being opened that has been gathered and processed, the client module 102 of the antivirus system for antivirus scanning of web pages 110 composes and sends requests 130 for scanning the text of the web pages in markup language to an antivirus server 140 with the use of the available communications channel 120.

The communications channel 120 is a connection for the transmission of information between the client module 102 of the antivirus system for scanning web pages 110 and the antivirus server 140. The communications channel 120 may be any of the full array of technical means providing for a transmission of electrical signals from a message source to a user, including via the Internet and other networks. The capacity of the communications channel 120 is the maximum amount of information units per unit of time that can be transmitted through the information transmission channel.

The antivirus server 140 in a system for antivirus scanning of web pages may be a computer server system configured to perform antivirus scanning of characters and strings of text of web pages being opened that are contained in requests 130 received from the client module 102 of the antivirus system for scanning 110. The antivirus server 140 may contain or be connected to databases used to perform the antivirus scanning, such as a database of descriptions of malicious web applications or a database of text in markup language whose processing by a browser results in the performance of malicious actions.

In order to ensure control of the productivity of the antivirus server 140 when performing the antivirus scan of web pages, a system is used for allocating a portion of the productivity reserve of the antivirus server in performing the antivirus scan of a web page.

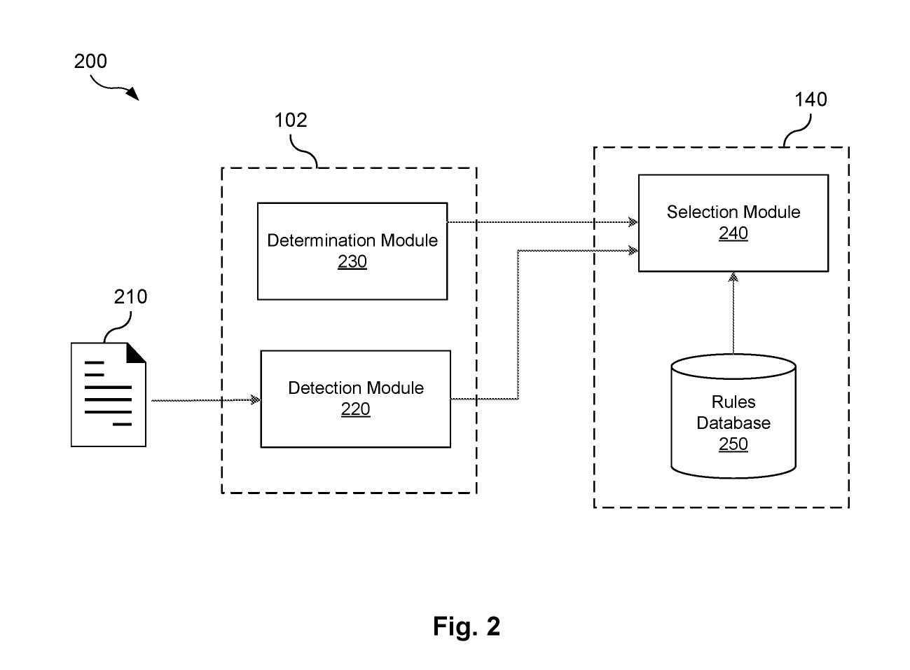

FIG. 2 shows a structural diagram of an example system 200 for allocating a portion of the productivity reserve of the antivirus server in performing the antivirus scan of a web page according to an exemplary aspect. In one exemplary aspect, the system 200 for allocating a portion of the productivity reserve of the antivirus server in performing the antivirus scan of a web page includes a detection module 220, a determination module 230, a selection module 240, and a database 250.

The detection module 220 is configured to detect text in markup language of a web page being opened 210, generate a text set in markup language of the web page being opened for the antivirus scan, and transmit the generated text set in markup language of the web page being opened for the antivirus scan to the selection module 240.

In some exemplary aspects, the detection module 220 can be situated in the client module 102 of the antivirus system for scanning web pages 110 and make use of its functions. The user opens the web page 210 with the aid of a web browser. The detection module 220 is configured to detect the text in markup language of the web page being opened 210.

In some exemplary aspects, the detection module 220 detects text in markup language of a web page being opened 210 by pinpointing the successful execution of a series of interactions with a graphical user interface of the web browser which signify the request for and opening of a web page in the web browser for example: activation of an URL string entry field of the web browser, entry of the characters of the URL string in the active entry field and pressing of the <Enter> key. In the event that the requested web page exists, and the web server storing the text in markup language of the requested web page is available, or the instrument for its dynamic creation is available, the result of the performance of the aforementioned actions will be the detection of text in markup language of the web page being opened 210. In another exemplary aspect, the detection module 220 detects text in markup language of a web page being opened 210 by identifying a page transition by a hyperlink located on the already opened web page. Each successful transition by the hyperlink on the web page enables the detecting of text in markup language of the web page being opened 210. In the event that there are several web pages being opened, the detection of text in markup language of each web page will be done in turn as they are opened. In another exemplary aspect, the detection module 220 detects text in markup language of a web page being opened 210 by analyzing events altering the web page being opened. For example, the detection module 220 may be configured to detect one or more HTML mutation notifications (e.g., via a MutationEvent handler or MutationObserver callback function) which are dispatched by a web browser application as notifications of any changes to the structure of the web page document, including attribute, text, or name modifications. In the course of the analysis, the detection module 220 detects additional new characters or strings of the web page in markup language, which are produced by the occurrence of that notification.

After detection of the text in markup language of the web page being opened 210, the detection module 220 generates a text set in markup language of the web page being opened for the antivirus scan. In some exemplary aspects, the text set in markup language of the web page being opened for the antivirus scan is a set of characters or strings of text in markup language of the web pages, or in other programming languages (such as JavaScript) in the context of the tags of markup language which have been prepared for the antivirus scan. The set may contain text characters or strings in markup language of several web pages.

The detection module 220 may generate the text set in markup language of the web page being opened by adding to the set individual text characters or strings of the web page being opened in markup language. In one exemplary aspect, the entire text of the web page being opened is added to the set, for example in the case when the size of the entire text in markup language of the web page being opened does not exceed a given value. In another exemplary aspect, the detection module 220 generates the text set in markup language of the web page being opened by adding only those strings which contain insertions with text of programs in programming languages, and also several lines of text in markup language of the web page being opened which come before and after them. In another exemplary aspect, the detection module 220 generates the text set in markup language of the web page being opened for the antivirus scan adding only the text characters and strings of the web page being opened in markup language that contain tags, such as <iframe>, </iframe> and so on. In yet another exemplary aspect, the detection module 220 generates the text set in markup language of the web page being opened for the antivirus scan by excluding those rows and columns of text in markup language of the web page being opened that have been previously dispatched, for example, during a repeated opening of the web page (refreshing of the web page display). In the event that there are several web pages being opened, or if the web page has a complex structure with many embedded web pages and hyperlinks, the detection module 220 may generate the text set in markup language of the web page being opened for the antivirus scan by alternately adding text strings or characters in markup language from each of the web pages being opened.

During generation, the text set in markup language of the web page being opened for the antivirus scan may be limited in size or in period of time. The maximum size of the text set in markup language of the web page being opened for the antivirus scan may be the maximum number of characters or bytes of information which the text set in markup language of the web page being opened for the antivirus scan can contain. The period of time for the generating of the text set in markup language of the web page being opened for the antivirus scan may be the period of time during which the text set in markup language of the web page being opened for the antivirus scan is generated.

In one exemplary aspect, in the course of a (sometimes lengthy) period of time of generation of the text set in markup language of the web page being opened for the antivirus scan, the user can continue to open various web pages whose individual text characters and strings in markup language go in turn into the set being generated. In another exemplary aspect, the text set in markup language of the web page being opened is generated during a short period of time, and in the course of the generation only those strings and characters are added, for example, that contain text of programs in the programming language JavaScript in the tags <script> </script>.

After completing the generation, the detection module 220 sends the generated text set in markup language of the web page being opened for the antivirus scan to the selection module 240.

The determination module 230 may be configured to determine the communications channel capacity between the client module 102 of the antivirus system for scanning web pages 110 and the antivirus server 140, to determine the productivity reserve of the antivirus server 140 and to transmit data on the calculated communications channel capacity and the determined productivity reserve of the antivirus server 140 to the selection module 240.

In some exemplary aspects, the productivity is the volume of work which can be done by a computer in a unit of time. For example, one can define this parameter as the number of tasks performed in a given time. The productivity of an antivirus server 140 in performing an antivirus scan of web pages is the number of text characters or bytes in markup language whose antivirus scan can be performed by the antivirus server 140 in a period of time. In some exemplary aspects, the peak productivity of an antivirus server in performing an antivirus scan of web pages may be the maximum number of text bytes or characters in markup language whose antivirus scan can be performed by the antivirus server without overload. In some exemplary aspects, the current productivity of an antivirus server in performing an antivirus scan of web pages may be the number of text bytes or characters in markup language whose antivirus scan can be performed by the antivirus server at the current moment of time. As such, the determination module 230 may calculate the productivity reserve as the difference between the value of the peak and the current productivity of the antivirus server, as measured by the additional number of text characters or bytes in markup language whose antivirus scan can be performed by the antivirus server to reach its peak productivity.

In one exemplary aspect, the determination module 230 may be situated in the client module 102 of the antivirus system for scanning web pages 110 and makes use of its functions. In this case, the determination module 230 is configured to determine the communications channel capacity between the client module 102 of the antivirus system for scanning web pages 110 and the antivirus server 140 by dispatching requests containing a verified text set in markup language of known size from the module of the antivirus system for scanning web pages 110 to the antivirus server 140, confirming the reception of the requests, and calculating the time spent on transmitting the verified text set in markup language of known size. The determination module 230 may determine the productivity reserve of the antivirus server 140 by periodically performing a “forced” antivirus scanning of the received verified text set in markup language of known size and calculating the time spent on its scanning. The determination module 230 re-scans a previously verified text set, of which the contents are “forced” to be considered unknown. This will cause the scan to be performed using the full set of antivirus server capabilities. The size of the received set is known, and the antivirus server 140 is able to give notice as to the ending of the scan or the current productivity during the performance of the antivirus scan, which makes it possible to calculate the productivity reserve of the antivirus server 140. Put another way, since the size of the received set and the scan verdict are already known from the previous check, based on the information about the results of the forced re-scan, the determination module 230 is able to draw a conclusion about the current performance of the antivirus server 140. After a time, it is possible to re-scan the same set, forcing the server to consider it unknown.

In an alternative exemplary aspect, the determination module 230 may be situated on the antivirus server 140 and makes use of its functions. In this case, the determination module 230 determines the communications channel capacity between the client module of the antivirus system for scanning web pages 110 and the antivirus server 140 by dispatching requests (responses to a request) containing a verified text set in markup language of known size from the antivirus server 140 to the client module 102 of the antivirus system for scanning 110, confirming the reception of the verified text set in markup language of known size, and calculating the time spent on the transmission. In this case, the determination module 230 has constant access to the data on the productivity reserve of the antivirus server 140.

The determination module 230 constantly maintains up-to-date information on the communications channel capacity between the module of the antivirus system for scanning web pages 110 and the antivirus server 140, and therefore does not have to be dependent on the results of the working of the detection module 220. The determination module 230 transmits data on the calculated communications channel capacity and the determined productivity reserve of the antivirus server 140 to the selection module 240.

The selection module 240 is configured to select the speed of dispatching information from the module of the antivirus system for scanning web pages 110 to the antivirus server 140 on the basis of the generated text set in markup language of the web page being opened for the antivirus scan, the determined communications channel capacity, and the determined productivity reserve of the antivirus server 140 with the use of one or more speed selection rules from the rules database 250. The selection module 240 may be also configured to calculate the portion of the determined productivity reserve of the antivirus server 140 needed to perform the antivirus scan of the generated text set in markup language of the web page being opened for the antivirus scan, taking into account the selected speed of information dispatching, and allocate the calculated portion of the productivity reserve of the antivirus server 140.

In one exemplary aspect, the selection module 240 may be situated on the antivirus server 140 and is configured to select the speed of information dispatching from the client module 102 of the antivirus system for scanning web pages 110 to the antivirus server 140 on the basis of the data received from the detection module 220 and the determination module 230 with the use of speed selection rules from the rules database 250.

In some exemplary aspects, the speed of dispatching information from the module of the antivirus system for scanning web pages 110 to the antivirus server 140 may be represented by the number of bytes occupied by the text in markup language of the web page being opened for the antivirus scan per second that is being dispatched by the client module 102 of the antivirus system for scanning web pages 110 to the antivirus server 140 in the form of requests.

The exchange of information between the client module 102 of the antivirus system for scanning web pages 110 and the antivirus server 140 is done by sending requests to the antivirus server 140 and receiving responses. For example, once more referring to FIG. 1, the request 130 may be a hypertext transfer protocol (HTTP) message dispatched by the client module 102 of the antivirus system for antivirus scanning of web pages 110 to the antivirus server 140. An HTTP message is the basic unit of HTTP communications, comprised of a structured sequence of octets, composed according to HTTP syntax, and transmitted by the available connection. HTTP messages can be of two types: a request from a client to the server and a response from the server to the client. The core of the request (response) 130 includes information transmitted as the payload of the request or response. It is understood that certain aspects of the present disclosure can be implemented using other communication protocols besides HTTP, and a protocol with a different syntax of requests and responses can be used, such as Simple Network Management Protocol (SNMP).

The selection module 240 may be configured to change the speed of dispatching the information by specifying a request payload size (RPS) 132 and a request sending time interval (RSTI) 134 for the request(s) 130. In some exemplary aspects, the antivirus serer 140 modifies its behavior with respect to communications with the client module 102 to enforce the new RPS and RSTI settings as configured by the selection module 240. In some exemplary aspects, the payload size 132 of the request 130 may be the number of bytes of data being transmitted, apart from service commands and information needed for dispatching the request, e.g., data after the headers and CRLF of a HTTP request. For example, the payload can be strings and characters of a text set in markup language of a web page being opened. In some exemplary aspects, the time interval 134 between sending of requests 130 (e.g., RSTI) may be the segment of time between two consecutive dispatches of requests 130.

As mentioned earlier, the selection module 240 may use one or more speed selection rules from the rules database 250. A speed selection rule may be a set of conditions by which the selection module 240 selects the speed of dispatching information from the client module 102 of the antivirus system for scanning web pages 110 to the antivirus server 140. In some exemplary aspects, a speed selection rule may include conditions for the productivity reserve of the antivirus server 140, the communications channel capacity, and the size of the text set in markup language of the web page being opened for the antivirus scan.

The rules database 250 is configured to store the speed selection rules. Different kinds of databases can be used as the rules database 250, namely: hierarchical (IMS®, TDMS, System 2000), neural net (Cerebrum, Cronospro, DBVist), relational (DB2®, Informix®, Microsoft SQL) Server®, object-oriented (Jasmine®, Versant®, POET®), object-relational (Oracle Database®, PostgreSQL™, FirstSQL/J®), functional, and so forth. The rules database 250 can be supplemented or updated with the aid of the antivirus server 140.

In some exemplary aspects, a speed selection rule may be configured to limit the utilization of the entire productivity reserve of the antivirus server 140 based on the communications channel capacity, and can have the following list of conditions: if the productivity reserve of the antivirus server 140 is greater than the communications channel capacity, while the size of the text set in markup language of the web page being opened has a larger value than the value of the capacity in one second, then a speed of information dispatching is selected which is equal to or less than the communications channel capacity. For example, the selection module 240 may determine the conditions of the above-described speed selection rule is satisfied by a situation in which the productivity reserve is 500,000 bytes per second, the communications channel capacity is 125,000 bytes per second, and the size of the text set in markup language of the web page being opened for the antivirus scan is 1,000,000 bytes. In this case, the communications channel capacity limits the utilization of the entire productivity reserve of the antivirus server 140 at a level of 125,000 bytes per second. Therefore, the selection module 240 determines the speed of dispatching information as 125,000 bytes per second, by changing the request payload size 132 to a value of 12,500 bytes, and the request sending time interval 134 to 0.1 seconds.

In another exemplary aspect, a speed selection rule can be configured to use the value of the productivity reserve to prevent the full utilization of the communication channel 120, and may have the following list of conditions: if the productivity reserve of the antivirus server 140 is less than the communications channel capacity, while the size of the text set in markup language of the web page being opened for the antivirus scan has a larger value than the value of the capacity in one second, then a speed of information dispatching is selected which is equal to or less than the productivity reserve of the antivirus server 140. For example, the selection module 240 determines that the above-described set of conditions is satisfied by a situation in which the determined productivity reserve is 100,000 bytes per second, the determined communications channel capacity is 250,000 bytes per second, and the detected size of the text set in markup language of the web page being opened for the antivirus scan is 1,000,000 bytes. In this case, the value of the productivity reserve of the antivirus server does not allow full utilization of the communication channel capacity and limits it to a level of 100,000 bytes per second. Therefore, the selection module 240 determines the speed of dispatching information as 100,000 bytes per second, by changing the request payload size 132 to a value of 10,000 bytes, and the request sending time interval 134 to 0.1 seconds.

In another exemplary aspect, a speed selection rule may be configured to prevent use of the antivirus server 140 on account of the risk of overloading the server, and have the following list of conditions: if the productivity reserve tends toward zero, the communication channel capacity is other than zero, and the size of the text set in markup language of the web page being opened for the antivirus scan has a larger value than the value of the capacity per second, then a speed of information dispatching is selected which is equal to zero, and the generated text set in markup language of the web page being opened is sent on for additional generation of several seconds. For example, the selection module 240 may determine that this set of conditions is met by a situation in which the determined productivity reserve is 0 bytes per second, the communications channel capacity is 250,000 bytes per second, and the size of the text set in markup language of the web page being opened for the antivirus scan is 1,000,000 bytes. In this case, it is undesirable to use the antivirus server 140 in the usual way on account of the risk of an overload. Therefore, the selection module 240 selects the speed of dispatching information as 0 bytes per second by changing the request payload size 132 to a value of 0 bytes, the request sending time interval 134 to 0 seconds, and the generated text set in markup language of the web pages is sent on for additional generation of 10 seconds.

The selection module 240 may also calculate the portion of the determined productivity reserve of the antivirus server 140 for performing the antivirus scan of the generated text set in markup language of the web page being opened taking into account the selected speed of information dispatching. Responsive to this, the selection module 240 allocates the calculated portion of the productivity reserve of the antivirus server 140.

On the basis of the selected information dispatching speed, the selection module 240 may calculate the portion of the productivity reserve of the antivirus server 140 to perform the antivirus scan of the generated text set in markup language of the web page being opened for the antivirus scan. For example, responsive to determining the information dispatching speed is equal to 100,000 bytes per second, the productivity reserve of the antivirus server is equal to 500,000 bytes per second, and the size of the text set of the web page in markup language for the antivirus scan is equal to 1,000,000 bytes, the selection module 240 calculates 100,000 bytes per second for 10 seconds as the allocated portion of the productivity reserve of the antivirus server 140.

The selection module 240 then allocates the portion of the productivity reserve of the antivirus server at 100,000 bytes per second for 10 seconds and initiates the performance of the antivirus scan of the web page being opened. Thus, the reserve of the antivirus server 140 after allocating the aforementioned portion will be 400,000 bytes per second for 10 seconds. After 10 seconds, the antivirus scan finishes and the antivirus server will again have a productivity reserve of 500,000 bytes per second.

In one exemplary aspect, the selection module 240 allocates and utilizes the portion of the productivity reserve of the antivirus server 140 by assigning priorities to the requests received. In another exemplary aspect, the selection module 240 allocates and utilizes the portion of the productivity reserve of the antivirus server 140 by calling upon unutilized resources of the antivirus server 140 (RAM, processor time, and so on).

While FIG. 2 depicts a single detection module 220 and determination module 230 part of the client module 120 and a single selection module 240 part of the antivirus server 140 of the antivirus system 200, exemplary aspects of the present disclosure may use different configurations of the antivirus system 200 having multiples of the modules and/or situated differently in the client and server side. For example, in one exemplary aspect, the antivirus system 100 for scanning of web pages may have several modules 102 of the antivirus system for scanning web pages 110 and one available communications channel 120 by which each of the several modules 102 of the antivirus system for scanning web pages 110 are connected to one antivirus server 140. For example, the system 100 may have multiple modules 102 in a situation in which three web browsers are installed on the computer system 101 of the user. One module of the antivirus system for scanning web pages 110 apiece may be installed on two of the web browsers, being realized in the form of an extension to the web browser. On the third web browser, a web page can be opened in which the client module 102 of the antivirus system for scanning web pages 110 is realized in the form of a JavaScript module part of the web page. In this case, the system for allocating a portion of the productivity reserve of the antivirus server for performance of the antivirus scan of the web page may include three detection module 220, one determination module 230 and one selection module 240, connected to the rules database 250. In such cases, for a uniform distribution, the communications channel capacity is distributed among the detection module 220. For example, the value of the communications channel capacity may be divided into three equal portions.

In another exemplary aspect, the antivirus system 100 for scanning of web pages can have several modules 102 of the antivirus system for scanning web pages 110 and a separate available communications channel 120 corresponding to each module, connecting each of the modules of the antivirus system for scanning web pages 110 to one antivirus server 140. For example, when three users on personal computer systems with an installed web browser and the client module 102 of the antivirus system for scanning web pages 110, which is realized in the form of an extension to the web browser, open web pages, and only one antivirus server 140 of the several which are present is available at the given time. In this case, the system for allocating a portion of the productivity reserve of the antivirus server for performance of the antivirus scan of the web page may include three detection modules 220, three determination modules 230 and one selection module 240, connected to the rules database 250. In such cases, for a uniform distribution, the productivity reserve of the antivirus server 140 is distributed among the determination modules 230. For example, the value of the productivity reserve of the antivirus server 140 is divided into three equal portions.

In yet another exemplary aspect, the antivirus system for scanning of web pages can have one client module 102 of the antivirus system for scanning web pages 110 and a corresponding communications channel 120 by which the client module 102 of the antivirus system for scanning web pages 110 is connected to several antivirus servers 140. For example, when one user on a computer system with the installed web browser and the client module 102 of the antivirus system for scanning web pages 110, which is realized in the form of an extension to the web browser, opens web pages, and three antivirus servers 140 are available. In this case, the system for allocating a portion of the productivity reserve of the antivirus server for performance of the antivirus scan of the web page may consist of one detection module 220, one determination module 230 and three selection modules 240, connected to the rules database 250. In such cases, for a uniform distribution, the generated text set in markup language of the web page being opened for the antivirus scan is distributed among the determination module 230. For example, the generated text set in markup language of the web page being opened is divided into three equal portions.

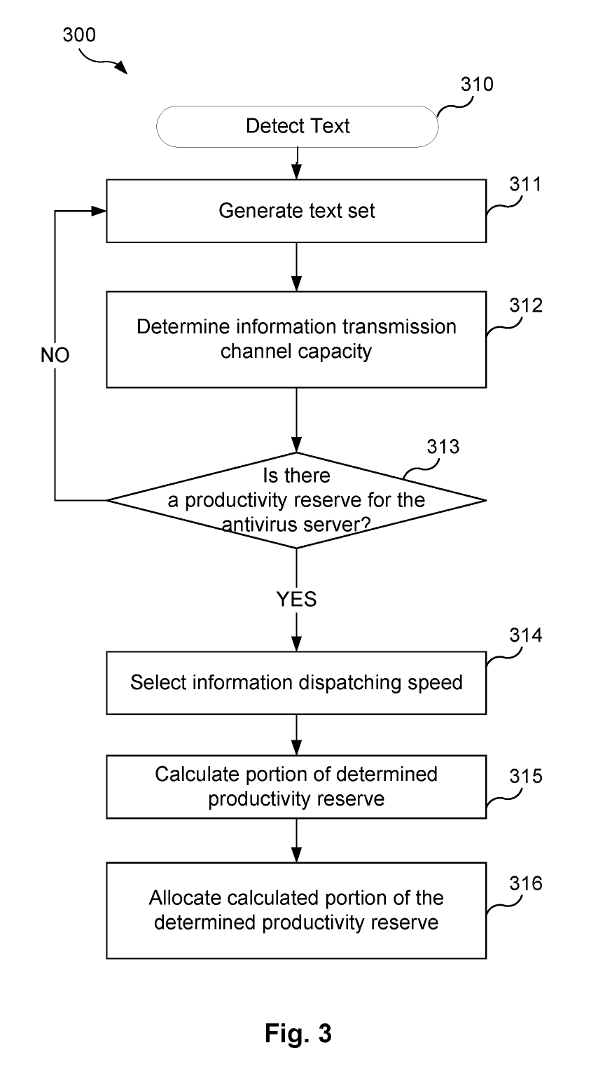

FIG. 3 illustrates a flowchart of a method 300 for allocating a portion of the productivity reserve of the antivirus server in performing the antivirus scan of a web page according to an exemplary aspect.

In step 310, the detection module 220 detects the text in markup language of the web page being opened 210. In some exemplary aspects, the detection module 220 detects a successful execution of a series of interactions with a graphical user interface of the web browser that signify an opening of the web page in the web browser. In some exemplary aspects, the detection module 220 detects a transition by a hyperlink located on the web page being opened. In some exemplary aspects, the detection module 220 detects one or more events generated by the web browser which indicate alteration of a document object of the web page being opened

In step 311, the detection module 220 generates the text set in markup language of the web page being opened for the antivirus scan and sends the generated text set of the web page being opened for the antivirus scan to the selection module 240. In some exemplary aspects, the detection module 220 generates the text set by adding characters and strings of text in markup language of the web page being opened that contain a tag. In other exemplary aspects, the detection module 220 generates the text set by adding strings containing an insertion of program text in a programming language.

In step 312, the determination module 230 determines the communications channel capacity between the client module 102 of the antivirus system for scanning web pages 110 and the antivirus server 140. In some exemplary aspects, the determination module 230 dispatches a plurality of requests containing a verified text set in markup language of a predetermined size, detects receipt of the requests, and calculates time spent on transmission of the verified text set in markup language of predetermined size.

In step 313, the determination module 230 determines whether the antivirus server 140 has a productivity reserve. In some exemplary aspects in which the determination module 230 is part of the client module 102, the antivirus server 140 may receive an indication of the productivity reserve as determined by the client module 102. In some exemplary aspects, the antivirus server 140 may determine the productivity reserve as the difference between the value of the peak and the current productivity of the antivirus server, as measured by the additional number of text characters or bytes in markup language whose antivirus scan can be performed by the antivirus server to reach its peak productivity.

If a productivity reserve is present in the antivirus server in step 313, the determination module 230 sends the data on the determined communications channel capacity between the client module 102 of the antivirus system for scanning web pages 110 and the antivirus server 140 and the data on the determined productivity reserve of the antivirus server 140 to the selection module 240. As such, in some exemplary aspects, the antivirus server 140 may receive, from the client module 102, a text set generated based on markup language of a web page being opened for an antivirus scan, and an indication of a capacity of a communications channel between the client module and an antivirus server.

In step 314, the selection module 240 selects the information dispatching speed from the client module 102 of the antivirus system for scanning web pages 110 to the antivirus server 140 on the basis of the generated text set of the web page being opened in markup language for the antivirus scan, the determined communications channel capacity, and the determined productivity reserve of the antivirus server 140. In some exemplary aspects, the antivirus server may select the speed of dispatching information from the module of the antivirus system for scanning of web pages to the antivirus server based on one or more speed selection rules from the rules database 250.

In step 315, the selection module 240 calculates the portion of the determined productivity reserve of the antivirus server 140 needed to perform the antivirus scan of the generated text set of the web page being opened in markup language, taking into account the selected information dispatching speed. In step 316, the selection module 240 allocates the calculated portion of the determined productivity reserve of the antivirus server 140. The antivirus system 140 may then perform the antivirus scan of the generated text set in markup language of the web page being opened using the allocated portion of the productivity reserve of the antivirus server.

If there is no productivity reserve left for the antivirus server in step 313 (i.e., “NO” branch of step 313), the determination module 230 sends the generated text set of the web page being opened for the antivirus scan to the detection module 220 for repeat generation of the generated text set in markup language of the web page being opened for the antivirus scan.

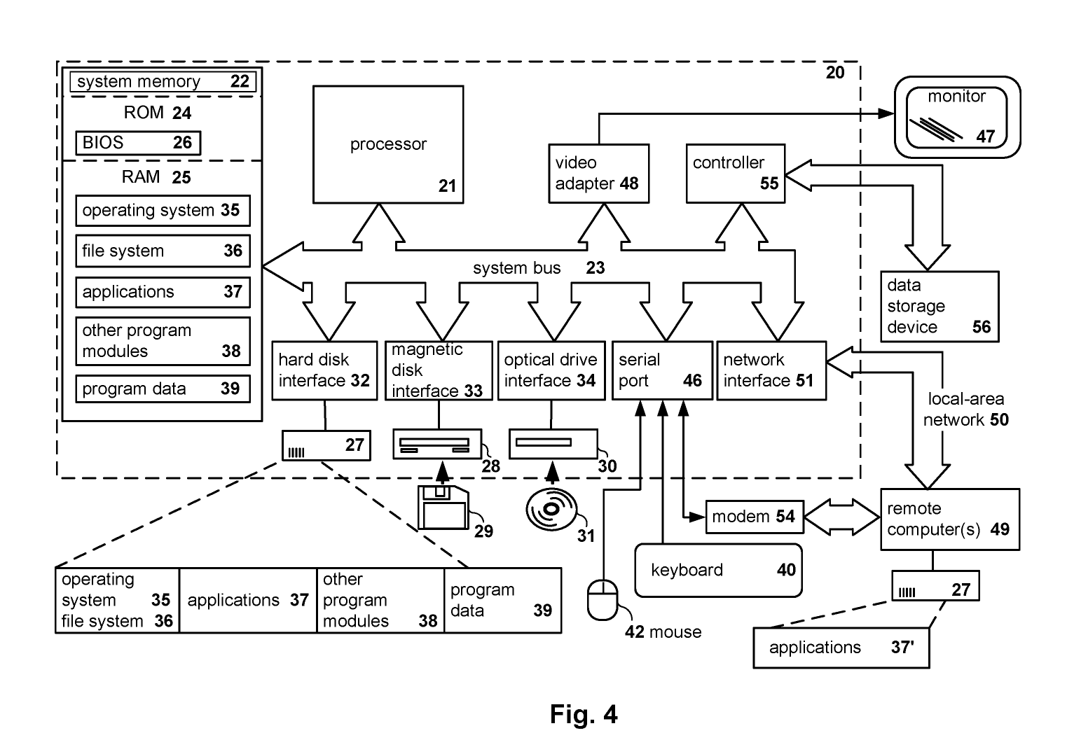

FIG. 4 is a diagram illustrating a general-purpose computer system 20 on which aspects of systems and methods for scanning web pages may be implemented in accordance with an exemplary aspect. The computer system 20 may be configured as the computer system 101 or as the antivirus server 140, described earlier.

As shown, the computer system 20 (which may be a personal computer or a server) includes a central processing unit 21, a system memory 22 and a system bus 23 connecting the various system components, including the memory associated with the central processing unit 21. As will be appreciated by those of ordinary skill in the art, the system bus 23 may comprise a bus memory or bus memory controller, a peripheral bus, and a local bus that is able to interact with any other bus architecture. The system memory may include permanent memory (ROM) 24 and random-access memory (RAM) 25. The basic input/output system (BIOS) 26 may store the basic procedures for transfer of information between elements of the computer system 20, such as those at the time of loading the operating system with the use of the ROM 24.

The computer system 20, may also comprise a hard disk 27 for reading and writing data, a magnetic disk drive 28 for reading and writing on removable magnetic disks 29, and an optical drive 30 for reading and writing removable optical disks 31, such as CD-ROM, DVD-ROM and other optical media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the computer system 20.

An exemplary aspect comprises a system that uses a hard disk 27, a removable magnetic disk 29 and a removable optical disk 31 connected to the system bus 23 via the controller 55. It will be understood by those of ordinary skill in the art that any type of media 56 that is able to store data in a form readable by a computer (solid state drives, flash memory cards, digital disks, random-access memory (RAM) and so on) may also be utilized.

The computer system 20 has a file system 36, in which the operating system 35, may be stored, as well as additional program applications 37, other program modules 38, and program data 39. A user of the computer system 20 may enter commands and information using keyboard 40, mouse 42, or any other input device known to those of ordinary skill in the art, such as, but not limited to, a microphone, joystick, game controller, scanner, etc. Such input devices typically plug into the computer system 20 through a serial port 46, which in turn is connected to the system bus, but those of ordinary skill in the art will appreciate that input devices may be also be connected in other ways, such as, without limitation, via a parallel port, a game port, or a universal serial bus (USB). A monitor 47 or other type of display device may also be connected to the system bus 23 across an interface, such as a video adapter 48. In addition to the monitor 47, the personal computer may be equipped with other peripheral output devices (not shown), such as loudspeakers, a printer, etc.

Computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes.

Network connections can form a local-area computer network (LAN) 50 and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the computer system 20 may employ a modem 54 or other modules well known to those of ordinary skill in the art that enable communications with a wide-area computer network such as the Internet. The modem 54, which may be an internal or external device, may be connected to the system bus 23 by a serial port 46. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a general purpose computer (such as the one described in greater detail in FIG. 3, supra). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. An antivirus system for performing an antivirus scan of a web page, the system comprising:
an antivirus server; and
a client module of the antivirus system for scanning of web pages module configured to:
detect text in markup language of a web page being opened;
generate a text set in the markup language of the web page being opened for the antivirus scan;
determine a capacity of a communications channel between the client module and the antivirus server; and
determine a productivity reserve of the antivirus server;
wherein the antivirus server is configured to:
select a speed of dispatching information from the client module to the antivirus server based on the generated text set in markup language of the web page being opened for the antivirus scan, the determined capacity of the communications channel, and the determined productivity reserve of the antivirus server;
allocate a portion of the determined productivity reserve of the antivirus server to perform the antivirus scan of the generated text set in markup language of the web page being opened, based on the selected information dispatching speed; and
perform the antivirus scan of the generated text set in markup language of the web page being opened using the allocated portion of the productivity reserve of the antivirus server.

2. The system of claim 1, wherein the antivirus server is further configured to select the speed of dispatching information from the module of the antivirus system for scanning of web pages to the antivirus server further based on at least one speed selection rule from a rules database.

3. The system of claim 1, wherein the client module configured to detect text in markup language of a web page being opened is further configured to:
detect a successful execution of a series of interactions with a graphical user interface of the web browser that signify an opening of the web page in the web browser.

4. The system of claim 1, wherein the client module configured to detect text in markup language of a web page being opened is further configured to:
detect a transition by a hyperlink located on the web page being opened.

5. The system of claim 1, wherein the client module configured to detect text in markup language of a web page being opened is further configured to:
detect one or more events generated by the web browser which indicate alteration of a document object of the web page being opened.

6. The system of claim 1, wherein the client module configured to generate the text set in the markup language of the web page being opened for the antivirus scan is further configured to add strings containing an insertion of program text in a programming language.

7. The system of claim 1, wherein the client module configured to generate the text set in the markup language of the web page being opened for the antivirus scan is further configured to add characters and strings of text in markup language of the web page being opened that contain a tag.

8. The system of claim 1, wherein the client module configured to determine the capacity of the communications channel between the client module and the antivirus server is further configured to:
dispatch a plurality of requests containing a verified text set in markup language of a predetermined size, detect receipt of the requests, and calculate time spent on transmission of the verified text set in markup language of predetermined size.

9. The system of claim 1, wherein the client module configured to determine the productivity reserve of the antivirus server is further configured to:
perform a forced antivirus scan of a verified text set in markup language of predetermined size, and calculate time spent on scanning the verified text set.

10. A method for performing an antivirus scan of a web page by an antivirus system, the method comprising:
receiving, from a client module of a web browser application, a text set generated based on markup language of a web page being opened for an antivirus scan;
receiving an indication of a capacity of a communications channel between the client module and an antivirus server;
determining a productivity reserve of the antivirus server;
selecting a speed of dispatching information from the client module to the antivirus server based on the received text set in markup language of the web page being opened for the antivirus scan, the received capacity of the communications channel, and the determined productivity reserve of the antivirus server;
allocating a portion of the determined productivity reserve of the antivirus server to perform the antivirus scan of the generated text set in markup language of the web page being opened, based on the selected information dispatching speed; and
performing, by the antivirus server, the antivirus scan of the generated text set in markup language of the web page being opened using the allocated portion of the productivity reserve of the antivirus server.

11. The method of claim 10, wherein determining the productivity reserve of the antivirus server comprises receiving an indication of the productivity reserve from the client module.

12. The method of claim 10, wherein selecting the speed of dispatching information from the client module of the antivirus system for scanning of web pages to the antivirus server is further based on at least one speed selection rule from a rules database.

13. The method of claim 10, wherein determining the capacity of the communications channel between the client module and the antivirus server further comprises:
dispatching a plurality of requests containing a verified text set in markup language of a predetermined size, detecting receipt of the requests, and calculating of time spent on transmission of the verified text set in markup language of predetermined size.

14. The method of claim 10, wherein determining the productivity reserve of the antivirus server further comprises:
performing a forced antivirus scan of a verified text set in markup language of predetermined size, and calculating time spent on scanning the verified text set.

15. The method of claim 10, wherein the speed of dispatching information from the client module to the antivirus server is selected by modifying a request payload size and a request sending time interval for requests from the client module.

16. A method for performing an antivirus scan of a web page by an antivirus system, the method comprising:
detecting, by a client module of the antivirus system, text in markup language of a web page being opened;
generating a text set in the markup language of the web page being opened for the antivirus scan;
determining a capacity of a communications channel between the client module and an antivirus server;
determining a productivity reserve of the antivirus server; and
transmitting, to the antivirus server, the web page being opened, to perform the antivirus scan, according to a dispatching information speed selected based on the determined capacity of the communications channel and the determined productivity reserve of the antivirus server.

17. The method of claim 16, further comprising:
transmitting, to the antivirus server, the determined capacity of the communications channel, and the determined productivity reserve of the antivirus server; and
directing the antivirus server to perform the antivirus scan of the generated text set in markup language of the web page being opened using an allocated portion of the productivity reserve of the antivirus server.

18. The method of claim 16, wherein the dispatching information speed specifies a request payload size and a request sending time interval.

19. The method of claim 16, wherein detecting text in markup language of the web page being opened comprises at least one of:
detecting a successful execution of a series of interactions with a graphical user interface of the web browser that signify an opening of the web page in the web browser;
detecting a transition by a hyperlink located on the web page being opened; and
detecting one or more events generated by the web browser which indicate alteration of a document object of the web page being opened.

20. The method of claim 16, wherein determining the capacity of the communications channel between the client module and the antivirus server further comprises:
dispatching a plurality of requests containing a verified text set in markup language of a predetermined size, detecting receipt of the requests, and calculating of time spent on transmission of the verified text set in markup language of predetermined size.
